(19) United States
(12) Patent Application Publication
(10) Pub. No.: US 2025/0331004 A1
(43) Pub. Date: Oct. 23, 2025

(54) USER EQUIPMENT, METHOD FOR BEAM MANAGEMENT IN SIDELINK COMMUNICATION, AND STORAGE MEDIUM

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/255,814

(22) Filed: Jun. 30, 2025

Related U.S. Application Data
(63) Continuation of application No. PCT/CN2023/071114, filed on Jan. 6, 2023.

(51) Int. Cl. H04W 72/25; H04B 7/06; H04L 5/00

(52) U.S. Cl. CPC H04W 72/25; H04B 7/0626; H04B 7/06952; H04L 5/0055

(57) ABSTRACT

A method for beam management in sidelink communication by a user equipment (UE) includes using a set of transmit beams to perform a sidelink transmission to another UE or a group of another UEs during a beam management process, receiving, from the another UE or the group of another UEs, a sidelink hybrid automatic repeat request (SL-HARQ) report, and selecting and/or determining a subset of one or more transmit beams based on the SL-HARQ report.

### CROSS REFERENCE TO RELATED APPLICATION(S)

This application is a continuation of International Application No. PCT/CN2023/071114, filed Jan. 6, 2023, the entire disclosure of which is incorporated herein by reference.

### BACKGROUND OF DISCLOSURE

### 1. Field of the Disclosure

The present disclosure relates to the field of communication systems, and more particularly, to a user equipment (UE), a method for beam management in sidelink communication, and a storage medium, which can provide a good communication performance and/or provide high reliability.

### 2. Description of the Related Art

In 3rd generation partnership project (3GPP) Release 16, the sidelink technology has been developed based on the latest 5th generation (5G) new radio (NR) access system including the support of frequency range 1 (FR1) bands (410 MHZ-7125 MHz), frequency range 2 (FR2) bands (24250 MHz-71000 MHz) and various OFDM transmission numerologies/sub-carrier spacings (SCSs) (15 k Hz, 30 k Hz, 60 k Hz, and 120 k Hz). One of the main motivations to support additional spectrum bands compared to the 4G long term evolution (LTE) system (i.e., frequency range 2, FR2) is the availability of large spectral bandwidth to support high data rate applications and various SCSs to allow very low latency radio transmissions for delay sensitive services. However, main drawbacks of using high frequency bands (i.e., in FR2) for radio transmission are the high attenuation of signal strength over distance from the transmitter (high pathloss) and the system is prone to frequency/phase errors due to the short wavelengths. For the NR sidelink system, it is claimed to support FR2 spectrum bands by introducing a phase tracking reference signal (PT-RS) in Release 16. However, no particular enhancement or feature has been supported in NR sidelink to combat/mitigate the high pathloss issue in FR2.

Therefore, there is a need for a user equipment (UE) and a method for beam management in sidelink communication, which can solve issues in the prior art, provide a beam management for sidelink communication, improve a sidelink (SL) communication performance, minimize/reduce a sidelink (SL) resource usage, and/or provide high reliability.

### SUMMARY

In a first aspect of the present disclosure, a method for beam management in sidelink communication by a user equipment (UE) includes using a set of transmit beams to perform a sidelink transmission to another UE or a group of another UEs during a beam management process, receiving, from the another UE or the group of another UEs, a sidelink hybrid automatic repeat request (SL-HARQ) report, and selecting and/or determining a subset of one or more transmit beams based on the SL-HARQ report.

In a second aspect of the present disclosure, a user equipment (UE) includes a memory, a transceiver, and a processor coupled to the memory and the transceiver. The UE is configured to perform the above method.

In a third aspect of the present disclosure, a non-transitory machine-readable storage medium has stored thereon instructions that, when executed by a computer, cause the computer to perform the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method for beam management in sidelink communication by a UE according to an embodiment of the present disclosure.

FIG. 5 is a schematic diagram illustrating a proposed UE-centric beamforming and beam management for SL GC and UC communications based on SL-HARQ feedback reporting according to an embodiment of the present disclosure.

FIG. 6 is a schematic diagram illustrating a proposed methods of SL-HARQ feedback in PSFCH for transmit beamforming and beam management for SL communication according to an embodiment of the present disclosure.

FIG. 7 is a schematic diagram illustrating a proposed TB-centric beamforming and beam management for SL GC communication based on NACK-only SL-HARQ reporting according to an embodiment of the present disclosure.

FIG. 8 is a block diagram of a UE for wireless communication according to an embodiment of the present disclosure.

FIG. 9 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In the advancement of radio wireless transmission and reception directly between two devices, which is often known as device-to-device (D2D) communication, it was first developed by 3rd generation partnership project (3GPP) and introduced in Release 12 (officially specified as sidelink communication) and improved in Release 13 for Public Safety emergency usage such as mission critical communication to support mainly low data rate and voice type of connection. In 3GPP Release 14, 15 and 16, the sidelink technology was advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology was further enhanced in Release 17 in the area of power saving and transceiver link reliability. For Release 18, 3GPP is currently looking to evolve the wireless technology and expand its operation into unlicensed frequency spectrum for larger available bandwidth, faster data transfer rate and easier market adoption of D2D communication using sidelink without requiring any mobile cellular operator's involvement to allocate and configure a part of their expansive precious radio spectrum for data services that do not go throughput their mobile networks.

Since 3GPP Release 16, the sidelink technology has been developed based on the latest 5th generation (5G) new radio (NR) access system including the support of frequency range 1 (FR1) bands (410 MHz-7125 MHz), frequency range 2 (FR2) bands (24250 MHz-71000 MHz) and various OFDM transmission numerologies/sub-carrier spacings (SCSs) (15 k, 30 k, 60 k and 120 k Hz). One of the main motivations to support additional spectrum bands compared to the 4G long term evolution (LTE) system (i.e., FR2) is the availability of large spectral bandwidth to support high data rate applications and various SCSs to allow very low latency radio transmissions for delay sensitive services. However, main drawbacks of using high frequency bands (i.e., in FR2) for radio transmission are the high attenuation of signal strength over distance from the transmitter (high pathloss) and the system is prone to frequency/phase errors due to the short wavelengths. For the NR sidelink system, it is claimed to support FR2 spectrum bands by introducing a phase tracking reference signal (PT-RS) in Release 16. However, no particular enhancement or feature has been supported in NR sidelink to combat/mitigate the high pathloss issue in FR2.

### Transmit Beamforming and Sweeping in Downlink

Over the downlink (DL) and uplink (UL) of the Uu interface, the concept/feature of transmit beamforming and beam management is developed and introduced since the beginning of the 5G-NR system in Release 15 to improve received signal strength, enhance cellular DL and UL coverages and minimize/reduce radio interference to neighbor cells. In order to enable this transmit beamforming/beam management feature over the Uu interface, particularly in the DL, the concept of beam sweeping is introduced by forming a transmit beam and sweeping it across all the directions in space (both horizontal and vertical spatial domains) that the base station (gNB) supports. Once a user equipment (UE) has received all the transmit beams or as many as it could (according to a pre-defined pattern and time interval), the UE selects a best beam and sends a physical random-access channel (PRACH) to the gNB in a RACH occasion that corresponds to the selected best beam. At the base station, gNB determines the selected best beam from the UE according to the received RACH occasion and uses the selected best beam to complete the random-access procedure in order for the UE to connect to the base station. The same best beam may be also used for subsequent data communication between the gNB and the UE until it is further updated/switched.

### Necessity of Transmit Beamforming and Beam Management in Sidelink

As mentioned previously, radio communication in high frequency spectrum (i.e., FR2 bands) may suffer from large attenuation in the transmitted signals and propagation loss through the space compared to the lower frequency bands that the cellular system traditionally operates. Besides the PT-RS that can be used by sidelink communicating devices to correct phase errors in the received carrier frequency in FR2 and the maximum device transmit power is limited by a device's power class definition, there is currently no other way to improve the communication range/signal coverage but to also support transmit beamforming and beam management for the NR sidelink technology. By improving the signal coverage/communication range for sidelink, it enables a few new use cases and applications for the users, such as enhancing the network coverage from SL relaying on a FR2 carrier and offloading network traffic onto a sidelink FR2 carrier for two UEs that are within the same cell.

### Back-to-Back (B2B)/Multi-Consecutive Slots Transmission (MCSt)

The original purpose of B2B transmission (which can be also referred as “burst transmission” or “multi-consecutive slot transmission”) is intended for a sidelink (SL) communicating UE to occupy an unlicensed spectrum channel continuously for a longer duration of time (i.e., more than one time slot) within an initiated channel occupancy time (COT) or a shared COT from another UE to mitigate the risk of losing access to the unlicensed spectrum channel to a wireless transmission (Tx) device of another radio access technology (RAT). This B2B transmission can be particular important and useful for a SL Tx-UE operating in an unlicensed radio frequency spectrum that has a large size of data transport block (TB) or medium access control (MAC) packet data unit (PDU), requires multiple retransmissions, sidelink hybrid automatic repeat request (SL-HARQ) feedback is disabled, and/or with a short latency requirement (small packet delay budget, PDB). When the unlicensed spectrum channel is busy/congested (e.g., with many devices trying to access the channel simultaneously for transmission), it can be difficult and take up a long time to gain access to the channel due to the random backoff timer and priority class category in a Type 1 listen-before-talk (LBT) procedure. And hence, when a UE finally has a chance/opportunity to gain access to the wireless channel for a COT length which may last for a few milliseconds (e.g., 2, 4, 6 or 10 ms), the intention is to retain the channel access for as long as possible (e.g., all or most of the COT length) to send as much data as possible by continuously transmitting in the unlicensed spectrum channel such that wireless devices of other RATs would not have a chance to access the channel.

### Sidelink HARQ Feedback for Groupcast and Unicast Communication

In order to support more advanced applications and use cases using the NR SL technology, such as vehicle platooning, autonomous driving in V2X and high data rate augmented reality (AR)/virtual reality (VR) in commercial applications, the feature of sidelink HARQ feedback for reporting of an acknowledgement (ACK) or negative-acknowledgement (NACK) from a reception UE (Rx-UE) to determine a subsequent retransmission of the same data TB from a Tx-UE was introduced in 3GPP Release 16 for sidelink groupcast (GC) and unicast (UC) communications.

In sidelink GC communication, two types of SL-HARQ feedback reporting mechanisms are supported, namely “groupcast option 1” and “groupcast option 2”. For “groupcast option 1”, only a NACK report is fed back in PSFCH from a Rx-UE when a received physical sidelink control channel (PSCCH) and physical sidelink shared channel (PSSCH) is not decoded successfully. That is, an ACK is not reported at all. This type of SL-HARQ feedback operation is intended for a connectionless groupcast communication based on a communication distance range, where the number of intended Rx-UEs within the distance range is unknown to the Tx-UE. For “groupcast option 2”, both ACK and NACK feedback reporting from a Rx-UE are supported for connection-oriented groupcast communication, where the total number of UE members in a same group is known to all UEs.

In sidelink UC communication, similar to groupcast option 2, both ACK and NACK feedback reporting from a Rx-UE are supported.

In some embodiments, for the present proposed transmit beamforming and beam management scheme for sidelink communication (e.g., in FR2 spectrum), a subset of one or more candidate transmit beams that can be used by a sidelink Tx-UE to improve SL communication performance are selected and determined based on sidelink HARQ acknowledgement (ACK) and/or negative-acknowledgement (NACK) feedback(s) from sidelink Rx-UEs within the same GC and UC communication such that SL resource usage is minimized/reduced from not always performing beam sweeping in all directions to deliver data information. Other benefits from adopting the proposed HARQ-based beamforming and beam management methods for SL communication may also include:

Further SL resource savings by eliminating the use of PSCCH and PSSCH for beam management and reporting. And hence, achieving a reduction in the overall sidelink traffic load and minimizing/reducing a half-duplex problem from performing less transmissions while supporting the beamforming and beam management feature to enhance the SL communication.

Achieve a fast indication and determination of candidate/best transmit beams from all Rx-UEs by reusing the existing and immediate SL-HARQ feedback signaling mechanism. And hence, no reliant/dependency on must having a PC5 radio resource control (RRC) between SL communicating UEs in order to support transmit beamforming and beam management.

The same beamforming and beam management process for the initial candidate/best beams selection can be also applied for beam failure recovery.

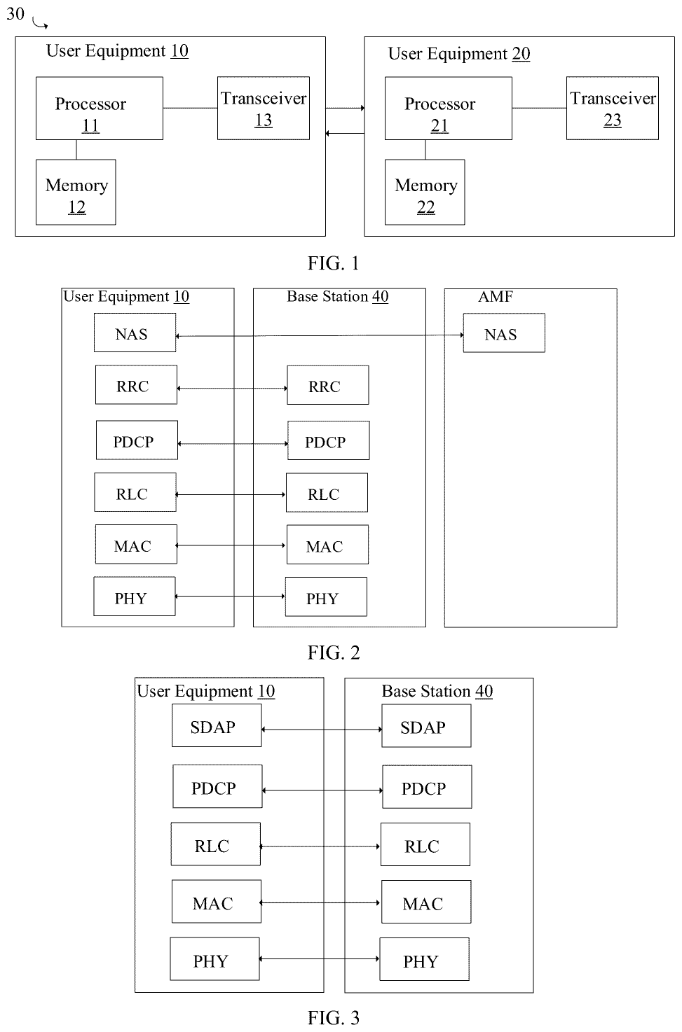

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR release 17 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 2 illustrates that, in some embodiments, in the control plane protocol stack where PDCP, RLC, and MAC sublayers and PHY layer may be terminated in a UE 10 and a base station 40 (such as gNB) on a network side and perform service and functions described above. In an example, RRC used to control a radio resource between the UE and a base station (such as a gNB). In an example, RRC may be terminated in a UE and the gNB on a network side. In an example, services and functions of RRC may comprise broadcast of system information related to AS and NAS, paging initiated by 5GC or RAN, establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an AMF for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the processor 11 is configured to use a set of transmit beams to perform a sidelink transmission to another UE 20 or a group of another UEs 20 during a beam management process, the transceiver 13 is configured to receive, from the another UE 20 or the group of another UEs 20, a sidelink hybrid automatic repeat request (SL-HARQ) report, and the processor 11 is configured to select and/or determine a subset of one or more transmit beams based on the SL-HARQ report. This can solve issues in the prior art, provide a beam management for sidelink communication, improve a sidelink (SL) communication performance, minimize/reduce a sidelink (SL) resource usage, and/or provide high reliability.

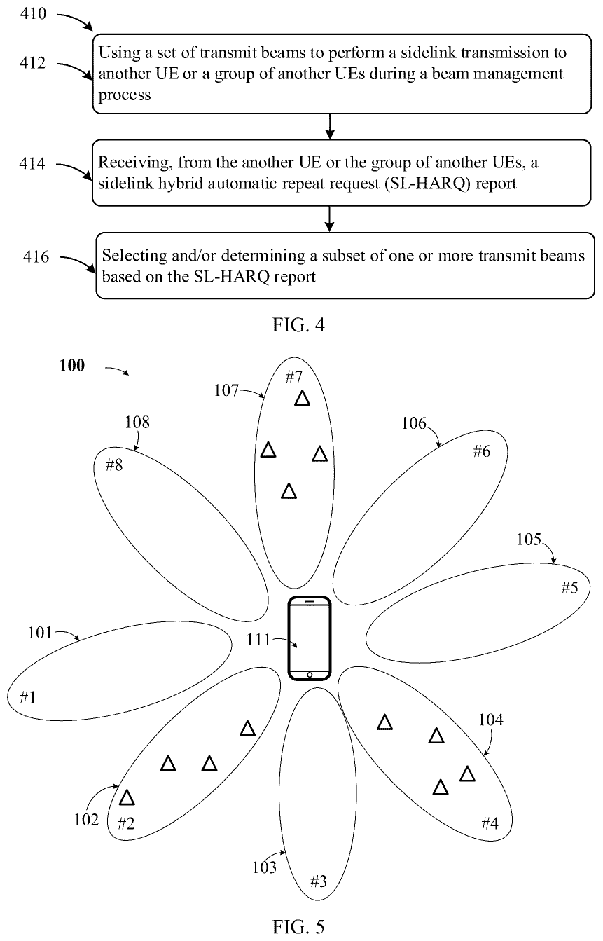

FIG. 4 illustrates a method 410 for beam management in sidelink communication by a UE according to an embodiment of the present disclosure. In some embodiments, the method 410 includes: a block 412, using a set of transmit beams to perform a sidelink transmission to another UE or a group of another UEs during a beam management process, a block 414, receiving, from the another UE or the group of another UEs, a sidelink hybrid automatic repeat request (SL-HARQ) report, and a block 416, selecting and/or determining a subset of one or more transmit beams based on the SL-HARQ report. This can solve issues in the prior art, provide a beam management for sidelink communication, improve a sidelink (SL) communication performance, minimize/reduce a sidelink (SL) resource usage, and/or provide high reliability.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### EXAMPLES

In some embodiments, for the present disclosure of new inventive beamforming and management methods for identifying and updating a set of one or more candidate/best transmit beams for (re) transmission of sidelink (SL) data transport block (TB), mainly targeting SL unicast and SL groupcast communications, the existing supported SL hybrid automatic repeat and request (HARQ) feedback mechanisms can be utilized to avoid additional resource usage and to minimize the time latency in performing the beam management.

For the existing SL-HARQ feedback mechanisms, as described earlier, acknowledgement (ACK) and negative-acknowledgement (NACK) reports are transmitted/provided by SL communication receiver UE using a physical sidelink feedback channel (PSFCH). In the existing SL slot structure, two orthogonal frequency division multiplexing (OFDM) symbols toward the end of a SL slot can be allocated/(pre-)configured for PSFCH transmission. Both symbols carry exactly the same feedback information (i.e., repeating), where the first symbol is intended to be used as a training symbol for the automatic gain control (AGC) at a receiver and not for information decoding. PSFCH resources/symbols can be (pre-)configured in every SL slot, every alternate SL slots or every fourth SL slots. This is referred as the PSFCH resource cycle/period (N=1, 2 or 4).

In order for a SL data reception UE (Rx-UE) to provide SL-HARQ feedback report after a decoding attempt of a received PSCCH and PSSCH to the original data transmission UE (Tx-UE), it is always assumed/required that the Rx-UE is able to complete the data decoding attempt and prepare a SL-HARQ report (a sequence signal for ACK or NACK depending on decoding success or failure) ready to be sent within two slots (K=2). That is, if a PSCCH and PSSCH is received in slot k by a Rx-UE, the corresponding SL-HARQ report (ACK, NACK or NACK-only) can be provided to the Tx-UE using an allocated/(pre-)configured PSFCH resource in slot k+2 at the earliest. If there is no PSFCH resource allocated/(pre-)configured in slot k+2 (e.g., when N=2 or 4), the SL-HARQ report is to be fed back in the next slot with PSFCH resources allocated/(pre-)configured. As such, depending on the PSFCH resource cycle/period length (N=1, 2, or 4), a PSFCH slot (i.e., a PSFCH symbol) may need to carry/multiplex SL-HARQ feedback reports for 1, 2 or 4 SL slots containing PSCCH and PSSCH.

Furthermore, the amount of PSFCH resources allocated/(pre-)configured in a slot may also provide a connection-oriented groupcast communication where multiple Rx-UEs need to provide individual SL-HARQ feedback report for the same transmitted PSCCH and PSSCH in a slot. That is, if there are 10 Rx-UEs in a connection-oriented groupcast session and “groupcast option 2” is indicated for the SL-HARQ feedback in sidelink control information (SCI), where an ACK and a NACK resource can be both provided per Rx-UE (to account for both possible decoding results), the total number of PSFCH resources required in this case would be 20. In the case of “groupcast option 1”, since the SL-HARQ feedback from a Rx-UE can contain only a NACK report when the data transport block (TB) decoding is a failure and the exact number of total Rx-UEs is unknown, a common PSFCH resource for the NACK-only feedback is suffice for a PSCCH and PSSCH transmission. For SL unicast communication, since there is always just one Rx-UE, two PSFCH resources are needed (one for ACK and the other for NACK).

In order to multiplex all SL-HARQ feedback reports within a PSFCH resource cycle/period, while accounting for different SL-HARQ feedback options and different SL cast types in a single PSFCH symbol, separate resource blocks (RBs) are allocated/(pre-)configured for SL-HARQ feedback of PSSCH transmission in different SL slots and individual cyclic prefix within an RB is used for code division multiplexing ACK/NACK reports from different Rx-UEs. As such, besides “groupcast option 1” where a common PSFCH resource is used for all Rx-UEs, the data TB transmitting Tx-UE can obtain after two slots a SL-HARQ feedback report from each intended Rx-UE individually for the transmitted PSCCH and PSSCH (including ACK, NACK, and/or discontinuous transmission (DTX)). A DTX means no SL-HARQ feedback report is provided due to no detection of a transmitted PSCCH and PSSCH at a Rx-UE. When this occurs, it represents the reception power of PSCCH is too low to be decodable, such that the Rx-UE could not even determine if a PSCCH is received and that a SL-HARQ feedback report can be provided. Therefore, by not obtaining a SL-HARQ feedback report that is expected from a Rx-UE, the Tx-UE can determine the PSCCH reception power is too low to be decodable/detectable. All-in-all, based on these feedback principles and characteristics in the existing design of SL-HARQ reporting, it is proposed in this present invention to enhance the reporting procedure in a manner that the SL-HARQ reporting could be also utilized for the purpose of transmit beamforming and beam management in sidelink communication.

Apart from saving resources and minimizing time latency in performing beam management for SL communication, another issue associated with reusing the legacy beamforming/beam sweeping technique from the 5G-NR Uu link especially in connectionless GC communication is related to overly repeating SL retransmissions of the same TB in all spatial directions (sweeping across all supported transmit beams) when only one NACK report is received.

Other challenges in performing beamforming and management in GC communication include also:

In the existing SL structure design, transmission of channel state information reference signal (CSI-RS) for radio channel condition measurement to support multiple-input and multiple-output (MIMO) for multi-layer transmission and channel quality indicator (CQI) adaptation in GC is not supported.

In sidelink GC communication, both connection-oriented and connectionless based, PC5 RRC signaling is not supported as well. consequently, no prior setup signaling is possible among member UEs in GC (connection-oriented) communication for exchange details on beamforming and beam management configurations.

In radio communication, the wireless propagation environment and channel conditions could potentially change very fast due to movement of the radio transmitter, the receiver, or even just the surrounding objects/vehicles. It is often observed that the rapid changing channel environment can cause a dramatic variation in the received signals strength/amplitude, phase rotation, and change in the frequency due to the Doppler effect. As such, if SL signals to be measured at a receiver UE for selecting a best beam are not transmitted rapidly/fast enough by the transmitter UE, the receiver UE would not be able to accurately determine which transmit beam(s) from the transmitter can provide the best performance.

### Proposed Transmit Beamforming and Beam Management Methods

In order to minimize the necessity and the amount of sweeping and management of transmit beams at a Tx-UE in sidelink GC and UC communications, which will subsequently reduce the amount of SL resources and Rx-UE processing time and decoding effort, as mentioned earlier, it is proposed to adopt a SL-HARQ feedback based transmit beam determination at least when performing SL re-transmissions for a same data packet TB. For a certain SL-HARQ feedback scheme (i.e., when both ACK and NACK can be reported), the same set of transmit beams used for the re-transmission is intended to be also used for transmitting other data packet TBs.

There can be two different methods of transmit beamforming and management for SL groupcast and unicast communications. The key difference lies in whether the selection of transmit beams is a UE-centric or TB-centric based determination, wherein the UE-centric based method aims to find a set of minimum number of best beams for all Rx-UEs and the TB-centric based method focuses on delivering each data TB with minimum number of retransmissions for all Rx-UEs.

### Exemplary Method 1 (UE-Based Transmit Beam Selection/Determination):

In the UE-centric based method for selecting/determining a subset of one or more transmit beam(s) as part of the beamforming and beam management in SL groupcast and unicast communications, wherein the SL-HARQ feedback reporting scheme indicated for the groupcast communication is based on “groupcast option 2” (for both ACK and NACK feedbacks), the key steps in the beam management process are:
Step 1. A set of transmit beams (e.g., a full set of transmit beams supported by the Tx-UE) is firstly used by the data packet TB Tx-UE during the process of an initial selection of transmit beams, the process of tracking/updating of transmit beams, and the process of beam failure recovery.
Step 2. Each Rx-UE decodes and measures every received SL transmission and feeds back an ACK or NACK SL-HARQ report for the best candidate beam in a PSFCH resource cycle/period.
Step 3. Based on all SL-HARQ reports received, at the Tx-UE, a subset of one or more transmit beam(s) are selected/determined on a per Rx-UE or a group of Rx-UEs basis.
Step 4. If necessary (e.g., not every Rx-UEs has reported ACK and/or the number of subset of transmit beams is high), the selected/determined subset of one or more transmit beam(s) is used for a subsequent retransmission of the same data packet TB and the step 2), 3) and 4) are repeated.

For the proposed exemplary Method 1, the final selected/determined subset of one or more transmit beam(s) is used by the Tx-UE for subsequent SL transmissions of data packet TBs in the same GC or UC communication until the process of tracking/updating of transmit beams or the process of beam failure recovery is performed. More specifically, the following Tx-UE and Rx-UE behaviors are described in detailed.

### Tx-UE Behavior

In order to initiate/trigger an initial beam selection process, a beam update process or a beam failure recovery process in a sidelink GC communication and subsequently for member UEs to provide SL-HARQ feedback reports for selecting/determining a subset of one or more transmit beam(s) at a Tx-UE, since PC5 RRC signaling is not supported in sidelink GC communication, the initiation/triggering is indicated to Rx-UEs using sidelink control information (SCI) and/or medium access control (MAC) control element (CE).

In a sidelink UC communication, the above initiating/triggering of an initial beam selection process, a beam update process or a beam failure recovery process could be performed via SCI, MAC CE and/or PC5 RRC signaling of configuring a set of SL resources which could be periodically occurring.

For the initial transmission of a data packet TB using a set of transmit beams in Step 1) above (e.g., a full set of transmit beams supported by the Tx-UE), multi-consecutive slots transmission (MCSt), where SL resources are selected and reserved in multiple consecutive slots, can be used by the Tx-UE to mitigate/minimize the effect of a potentially fast changing propagation channel environment and to obtain fair/comparable measurement results in determining a best beam.

MCSt could be also used in the subsequent retransmission(s) of the same data packet TB using a subset of one or more transmit beam(s) in the above Step 4). Note that, during both the initial transmission and retransmission(s) of a data packet TB using a set of one or more transmit beams in Step 1) and 4) above could span more than one PSFCH resource cycle/period.

Depending on SL-HARQ feedback reports received from the Rx-UE(s) and their corresponding candidate beam indices/IDs, the Tx-UE may perform one or more rounds retransmission of the same data packet TB using the reported candidate beams until the Tx-UE is able to determine a final subset of one or more transmit beam(s) for the Rx-UE(s) (e.g., at least an ACK is received from each Rx-UE).

From each of the receive SL-HARQ feedback from the Rx-UE(s) within a PSFCH resource cycle/period, the Tx-UE determines the suitability of the transmit beam used during the last round of SL transmission. For example, a reported ACK means “suitable”, NACK means “not suitable” or “further evaluation”, and DTX means “not suitable” since the Rx-UE could not even decode PSCCH of the corresponding SL transmission in the last found. This implies transmit beams correspond to a DTX state may not be considered, and thus, may be excluded from the candidate beams for the Rx-UE.

If one or more ACKs are received from a Rx-UE, the corresponding transmit beam(s) used in the last round of SL transmission are deemed/considered as candidate beam(s) for the Rx-UE.

When more than one ACK is received in a sidelink UC communication, it is up to the Tx-UE to use the corresponding transmit beams for sending a subsequent data packet TB to further down-select to a final best transmit beam for the Rx-UE. For a sidelink GC communication, it is up to the Tx-UE to associate multiple candidate beams per Rx-UE, such that the Tx-UE can flexibly group multiple Rx-UEs under the same transmit beam when the multiple Rx-UEs have a common candidate beam.

If no ACK is received and one or more NACKs are received, the transmit beams correspond to the NACK feedback reports are considered as candidate beams to be used for the subsequent retransmission of the same data packet TB. When one or more ACKs are received from the Rx-UE for the subsequent retransmission of the same data packet TB, the corresponding transmit beam(s) are considered as updated candidate beam(s) for the Rx-UE.

During the retransmissions of the same data packet TB, the transmit beam index/ID used for each of the retransmissions can be indicated, such that the Rx-UE is able to combine soft-bits of the data packet TB from the retransmission(s) that used the same transmit beam index/ID and accurately determine which transmit beam(s) provided the best performance for the SL GC or UC communication.

### Rx-UE Behavior

Up on reception of SL transmissions indicated in SCI, MACE CE and/or PC5 RRC from a Tx-UE for an initial selection of transmit beam(s), update of transmit beam(s), or recovering from beam failure detection in a sidelink GC or UC communication, an intended/member Rx-UE from the same GC or UC communication performs at least one of the following: Decoding and measurement of each received SL transmission (PSCCH and PSSCH) of the same data packet TB within the allocated SL slots and frequency resources (e.g., resource assignment for MCSt).

During the decoding of different PSSCH transmissions for the same data packet TB over a number of SL slots, the Rx-UE may not combine soft-bits across the different PSSCH transmissions that use different transmit beams to improve PSSCH decoding performance/reliability. In order to achieve a fair and accurate comparison of SL communication performance from using different transmit beams (based on decoding results of PSSCH for the same data packet TB), the Rx-UE may only combine soft-bits from using the same transmit beam (i.e., from different rounds of (re) transmission of the same data packet TB) to improve the decoding result.

The measurement of each received SL transmission in UC communication could be based on a reference signal received power of CSI-RS for sidelink (e.g., SL CSI-RSRP).

As mentioned earlier, since CSI-RS transmission is not supported in sidelink GC communication, the corresponding measurement could be based on other SL signals such as PSCCH or PSSCH demodulation reference signal (DM-RS) for sidelink RSRP measurement.

Transmitting a SL-HARQ ACK or NACK feedback report in PSFCH based on decoding result corresponding to the best/highest measurement in each PSFCH resource cycle/period.

In the case of PSFCH resource cycle/period is one (N=1), the Rx-UE feeds back SL-HARQ report for every received SL transmission. For DTX, no SL-HARQ feedback report is transmitted in PSFCH. If there is at least one ACK is determined within a PSFCH resource cycle/period, only ACK is reported. If there are more than one ACK per PSFCH resource cycle/period is determined, only the ACK corresponding to the highest measured RSRP is reported.

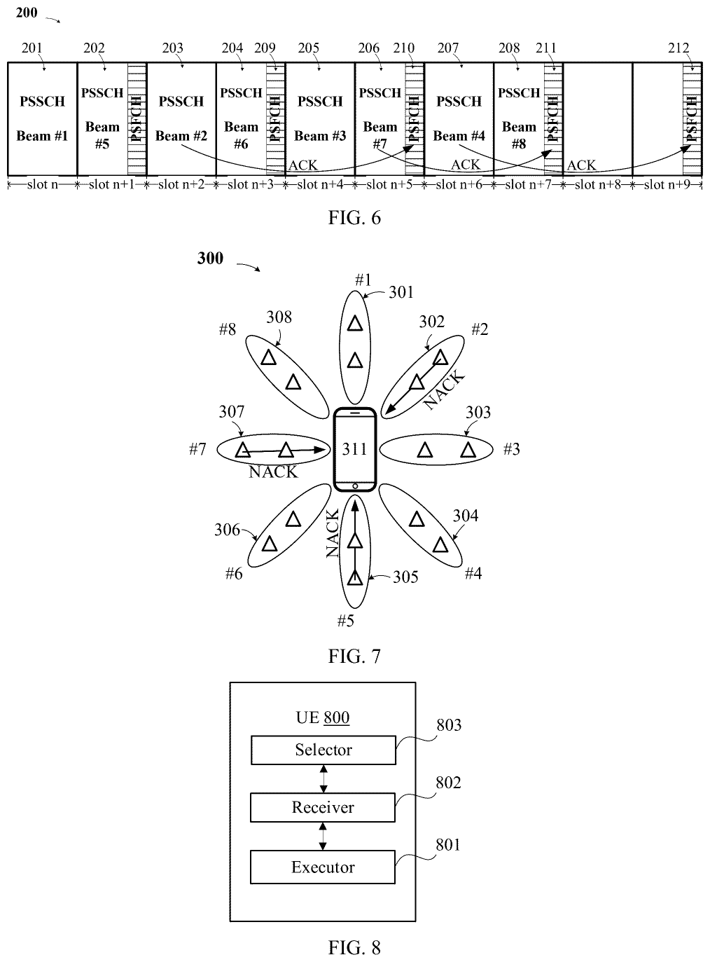

In reference to diagram 100 and diagram 200 in FIG. 5 and FIG. 6, respectively, exemplary illustrations of SL-HARQ feedback based transmit beamforming and beam management scheme according to the proposed exemplary Method 1 are illustrated for the case of sidelink groupcast communication. It is assumed the indicated SL-HARQ feedback scheme is based on a “groupcast option 2”, where an ACK or a NACK is reported according to a SL data packet TB decoding result. According to the example illustration diagram 100, a sidelink Tx-UE 111 in the connection-oriented groupcast session communicating with a number of other member

UEs is capable of generating/producing a set of 8 transmit beams with indices #1 to #8 (101 to 108). As illustrated in some embodiments of FIG. 5, the locations of the other member UEs are not scattered in all directions but rather grouped in 3 different clusters. Therefore, instead of performing a beam sweeping across all directions to deliver data packet TBs from the sidelink Tx-UE 111 every time, it is much more efficient, resource saving, power saving and higher reliability if SL transmissions of the data packet TBs can be focused only in the directions where the other members UEs are located (i.e., using transmit beam #2 102, transmit beam #4 104 and transmit beam #7 107 only).

According to the proposed exemplary Method 1 of the SL-HARQ feedback based transmit beamforming and beam management for connection-oriented GC communication, for the initial selection of transmit beam(s), the Tx-UE 111 may firstly perform multiple initial transmissions of a same data packet TB repeatedly using MCSt over 8 consecutive SL slots 201 to 208, each using a different transmit beam supported by the Tx-UE (from beam index #1 to #8). As illustrated in some embodiments of diagram 200, the transmit beam indices used in transmitting the repeated initial transmissions of the data packet TB across the SL slots 201 to 208 are not in sequence. In fact, the transmit beam index used across the SL slots can be randomized to avoid adjacent or nearby transmit beams are used within a same PSFCH resource cycle/period. If adjacent or nearby transmit beams are used within a same PSFCH resource cycle/period, it forces the Rx-UE to report SL-HARQ for a transmit beam with a higher SL measurement. In certain cases, this is not ideal because more than one transmit beams can be considered as candidate beams from the same PSFCH resource cycle/period. Therefore, transmit beams that are wide apart from each other can be used within a same PSFCH resource cycle/period to avoid a such undesirable consequence.

For these simple exemplary illustrations, let's further assume PSFCH resources are (pre-)configured every two slots in a SL resource pool (i.e., PSFCH resource cycle/period N=2). According to the existing SL-HARQ feedback timing design with a minimum of K=2 slots gap between a received SL PSSCH and the corresponding PSFCH transmission occasion, for SL PSSCH received in slot n (201) and slot n+1 (202), their corresponding PSFCH transmission occasions for SL-HARQ feedback are in the same PSFCH symbol 209 in slot n+3. Similarly, PSFCH symbol 210 in slot n+5 is the corresponding SL-HARQ feedback occasion for PSSCH received in slot n+2 (203) and slot n+3 (204). PSFCH symbol 211 in slot n+7 for PSSCH received in slot n+4 (205) and slot n+5 (206). PSFCH symbol 212 in slot n+9 for PSSCH received in slot n+6 (207) and slot n+7 (208). Since no other member UE in the same GC communication is located under the coverage of transmit beam index #1 and #5, it is assumed no SL-HARQ feedback is reported in PSFCH resource occasion 209.

Furthermore, since some of the other member UEs are under the coverage of transmit beam index #2, let's assume they all have reported ACK in PSFCH resource occasion 210. Similarly, for transmit beam index #7, some of the Rx-UEs have reported ACK in PSFCH resource occasion 211. For transmit beam index #4, the rest of the Rx-UEs reported ACK in PSFCH resource occasion 212. As such, the Tx-UE 111 selects/determines transmit beams with indices #2, #7 and #4 as the final subset of transmit beams for future SL transmissions of other data packet TBs.

### Exemplary Method 2 (TB-Based Transmit Beam Selection/Determination):

In the TB-centric based method for selecting/determining a subset of one or more transmit beam(s) as part of the beamforming and beam management in SL groupcast communication, wherein the SL-HARQ feedback reporting scheme indicated for the groupcast communication is based on “groupcast option 1” (for only NACK feedbacks), the key steps in the beam management process are:
Step A. For every data packet TB, a set of transmit beams (e.g., full set of transmit beams supported by a Tx-UE) is used by a Tx-UE whenever performing the initial transmission of a data packet TB in all directions, since the objective/intention of this type of GC communication is to deliver data packet TBs to all surrounding Rx-UEs (with no fixed directions) within a communication range.
Step B. Each intended Rx-UE within the same GC communication decodes and measures all received initial transmissions of the same data packet TB from the Tx-UE and feeds back a NACK report for the best candidate beam in a PSFCH resource cycle/period only if the decoding is a failure.
Step C. When at least one NACK SL-HARQ report is received and a maximum number of transmissions for the data packet TB is not reached, at the Tx-UE, a subset of one or more transmit beam(s) is selected/determined (e.g., down-selected from the previous used set of transmit beams) on a per data packet TB basis.
Step D. The selected/determined subset of one or more transmit beam(s) is used for the subsequent retransmission of the same data packet TB, and each intended Rx-UE that has not successfully decoded the same data packet TB may attempt to decode the TB again and the above step B), C) and D) are repeated until no more NACK reported is received or the maximum number of transmissions for the data packet TB has reached.

For the proposed exemplary Method 2, since the main objective/intention of this type of GC communication is to successfully deliver data packet TBs to surround Rx-UEs in all directions (as explained earlier), it is not necessary to identify or perform an initial selection of a subset of one or more best transmit beam(s) per intended Rx-UE as in the proposed exemplary Method 1 of the present disclosure. And hence, there would be no maintenance, tracking and updating the subset of one or more best transmit beam(s), or performing a beam failure recovery. The fundamental/principle mechanism behind the proposed exemplary Method 2 of beamforming and beam management for sidelink GC communication with a SL-HARQ feedback scheme of groupcast option 1 is to provide SL retransmission of the same data packet TB in a direction where an NACK report is received and a direction that will provide the best chance of decoding success for the Rx-UE.

### Tx-UE Behavior

For the initial transmission of a data packet TB using a set of transmit beams in Step 1) above (e.g., a full set of transmit beams supported by the Tx-UE), multi-consecutive slots transmission (MCSt), where SL resources are selected and reserved in multiple consecutive slots, can be used by the Tx-UE to mitigate/minimize the effect of a potentially fast changing propagation channel environment and to obtain fair/comparable measurement results in determining a best beam for a potential retransmission of the same data packet TB.

MCSt could be also used in the subsequent retransmission(s) of the same data packet TB using a subset of one or more transmit beam(s) in the above Step D). Note that, during both the initial transmission and retransmission(s) of a data packet TB using a set of one or more transmit beams in Step A) and D) above could span more than one PSFCH resource cycle/period.

Based on the reported NACKs for SL-HARQ feedback and their corresponding candidate beam indices/IDs, the Tx-UE performs one or more rounds retransmission of the same data packet TB using the reported candidate beams until no more NACK report is received or the maximum number of transmissions for the data packet TB is reached. When one or more NACK reports for SL-HARQ feedback are received, a subset of one or more transmit beam(s) correspond to the NACK feedback reports are selected/determined and used for the subsequent retransmission of the same data packet TB.

### Rx-UE Behavior

Up on reception of one or more SL transmission(s) of the same data packet TB for GC communication with “groupcast option 1” indicated as the SL-HARQ feedback reporting scheme in SCI, an intended Rx-UE from the same GC communication performs at least one of the following:

Decoding and measurement of each received SL transmissions (PSCCH and PSSCH) for the data packet TB within the allocated SL slots and frequency resources (e.g., resource assignment for MCSt) until the decoding is successful. In some examples, during the decoding of different PSSCH transmissions for the same data packet TB over the allocated SL slots, the Rx-UE may combine soft-bits from the different PSSCH transmissions that use different transmit beams to improve PSSCH decoding performance/reliability. As mentioned earlier, since CSI-RS transmission is not supported in sidelink GC communication, the corresponding measurement could be based on other SL signals such as PSCCH or PSSCH demodulation reference signal (DM-RS) for sidelink RSRP measurement.

Transmitting a NACK report for SL-HARQ feedback corresponding to the best/highest measurement in a PSFCH resource cycle/period when at least one decoding attempt has failed and the decoding of the data packet TB is not yet successful. In some examples, for DTX, no SL-HARQ feedback report is transmitted in PSFCH. If the decoding of the data packet TB is successful within a PSFCH resource cycle/period, the Rx-UE stops further decoding attempt for the same data packet TB and provides no SL-HARQ feedback for the PSFCH resource cycle/period.

In reference to diagram 300 in FIG. 6, exemplary illustrations of SL-HARQ feedback based transmit beamforming and beam management scheme according to the proposed exemplary Method 2 are shown for the case of sidelink groupcast communication. It is assumed the indicated SL-HARQ feedback scheme is based on a “groupcast option 1”, where only NACK is reported when a SL data packet TB decoding attempt is not a success. According to the example illustration diagram 300, a sidelink Tx-UE (311) in the connectionless groupcast session transmitting a SL data packet TB to its surrounding UEs is capable of generating/producing a set of 8 transmit beams with indices #1 to #8 (301 to 308). As illustrated in some embodiments, the locations of the surrounding UEs are scattered in all directions. Since the main purpose of a such connectionless SL groupcast communication is to successfully deliver data packet TBs to surrounding UEs within a communication range and the intended Rx-UEs are not fixed to a certain group of UEs, there is no sense of identifying a minimum subset of transmit beams that are specific to a certain group of UEs. The exact surrounding UEs and the number of surrounding UEs are likely to change from one data packet TB transmission to the next. Therefore, for the very initial transmission of every data packet TB, it is necessary for the Tx-UE to perform beam sweeping across all directions as a first SL transmission attempt to deliver the data packet TB to all of its surrounding UEs. Then based on SL-HARQ feedback of NACK-only reports, the Tx-UE may select/determine a subset of one or more transmit beams for retransmission(s) of the same data packet TB until no more NACK is received/reported.

According to the proposed exemplary Method 2 of the SL-HARQ feedback based transmit beamforming and beam management for connectionless GC communication, for the initial transmission of a SL data packet TB, the Tx-UE 311 performs the SL transmissions repeatedly in all directions using different transmit beams supported by the Tx-UE from beam index #1 to #8 (301 to 308). Different to the previous example illustration in diagram 200 of FIG. 6, the transmit beam indices used in transmitting the repeated initial transmissions of the data packet TB in exemplary Method 2 can be in sequence (i.e., adjacent/nearby transmit beams can be used in sequence). This is intended to achieve successful decoding of the data packet TB quickly, since the combining of soft-bits from the repeated initial transmissions that use different transmit beams to improve PSSCH decoding performance/reliability is the primary goal.

For these simple exemplary illustrations, let's assume out of the repeated initial transmissions of the same data packet TB, the Tx-UE detects at least one NACK is reported in each of the corresponding transmit beam indices #2 (302), #5 (305) and #7 (307). Therefore, the Tx-UE 311 selects/determines at least transmit beams #2 (302), #5 (305) and #7 (307) as the subset of transmit beams for the subsequent SL retransmissions of the data packet TB according to the proposed exemplary Method 2.

In summary, in order to minimize/reduce resource usage, reduce traffic load and saving transmission and processing power while improving sidelink groupcast and unicast communications performance for sidelink devices, two new inventive transmit beamforming and beam management methods based on SL-HARQ feedback reporting are proposed in some embodiments of the present disclosure. In some examples, for the proposed exemplary Method 1, the final selected/determined subset of one or more transmit beam(s) is used by the Tx-UE for subsequent SL transmissions of data packet TBs in the same GC or UC communication until the process of tracking/updating of transmit beams or the process of beam failure recovery is performed. In some examples, for the proposed exemplary Method 2, since the main objective/intention of this type of GC communication is to successfully deliver data packet TBs to surround Rx-UEs in all directions (as explained earlier), it is not necessary to identify or perform an initial selection of a subset of one or more best transmit beam(s) per intended Rx-UE as in the proposed exemplary Method 1 of the present disclosure. And hence, there would be no maintenance, tracking and updating the subset of one or more best transmit beam(s), or performing a beam failure recovery. The fundamental/principle mechanism behind the proposed exemplary Method 2 of beamforming and beam management for sidelink GC communication with a SL-HARQ feedback scheme of groupcast option 1 is to provide SL retransmission of the same data packet TB in a direction where an NACK report is received and a direction that will provide the best chance of decoding success for the Rx-UE.

FIG. 8 illustrates a UE 800 for wireless communication according to an embodiment of the present disclosure. The UE 800 includes an executor 801 configured to use a set of transmit beams to perform a sidelink transmission to another UE or a group of another UEs during a beam management process, a receiver 802 configured to receive, from the another UE or the group of another UEs, a sidelink hybrid automatic repeat request (SL-HARQ) report, and a selector 803 configured to select and/or determine a subset of one or more transmit beams based on the SL-HARQ report. This can solve issues in the prior art, provide a beam management for sidelink communication, improve a sidelink (SL) communication performance, minimize/reduce a sidelink (SL) resource usage, and/or provide high reliability.

In some embodiments, the beam management process includes a process of an initial selection of transmit beams, a process of tracking/updating of transmit beams, and/or a process of beam failure recovery. In some embodiments, initiating/triggering of the beam management process is performed by the UE using a sidelink control information (SCI) signaling and/or a medium access control (MAC) control element (CE) signaling in a sidelink groupcast communication (GC). In some embodiments, initiating/triggering of the beam management process is performed by the UE using an SCI signaling, a MAC CE signaling, and/or a PC5 radio resource control (RRC) signaling in a sidelink unicast communication (UC). In some embodiments, a multi-consecutive slots transmission (MCSt) is used by the UE in an initial transmission and one or more subsequent retransmissions of a data transport block (TB) during the beam management process. In some embodiments, the SL-HARQ report includes an acknowledgement (ACK) and/or negative-acknowledgement (NACK) for a best candidate beam in a physical sidelink feedback channel (PSFCH) resource cycle/period.

In some embodiments, for a same data TB, soft-bits across different physical sidelink shared channel (PSSCH) transmissions using a same transmit beam are combined. In some embodiments, a measurement of each sidelink transmission in a UC communication is based on a reference signal received power (RSRP) of channel state information reference signal (CSI-RS) for sidelink (SL CSI-RSRP). In some embodiments, a measurement of each sidelink transmission in a GC communication is based on a PSCCH or PSSCH demodulation reference signal (DM-RS) for sidelink RSRP measurement. In some embodiments, the SL-HARQ report is transmitted in a

PSFCH based on a decoding result corresponding to a best/highest measurement in each PSFCH resource cycle/period. In some embodiments, at least one of the following is met: if the PSFCH resource cycle/period is one, the UE receives the SL-HARQ report is for every sidelink transmission; for discontinuous transmission (DTX), no SL-HARQ report is transmitted in the PSFCH; if at least one ACK is determined within the PSFCH resource cycle/period, only the ACK is reported; and if more than one ACK per PSFCH resource cycle/period is determined, only the ACK corresponding to a highest measured RSRP is reported.

In some embodiments, based on the SL-HARQ report, the UE is configured to selects and/or determines the subset of one or more transmit beams on the another UE basis or the group of another UEs basis. In some embodiments, at least one of the following is met: based on the SL-HARQ report within the PSFCH resource cycle/period, the UE is configured to determine a suitability of the transmit beam used during a last round of SL transmission; if the UE receives one or more ACKs from the another UE or the group of another UEs, one or more corresponding transmit beams are considered as one or more candidate beams for the another UE or the group of another UEs; when the UE receives more than one ACK in a sidelink UC communication, the UE uses the corresponding transmit beams for sending a subsequent data TB to further down-select to a final best transmit beam for the another UE or the group of another UEs; when the UE receives more than one ACK in a sidelink GC communication, the UE associates multiple candidate beams per another UE or the group of another UEs; if no ACK is received and one or more NACKs are received by the UE, the transmit beams correspond to NACK feedback reports are considered as candidate beams to be used for a subsequent retransmission of a same data TB; and when one or more ACKs are received by the UE for the subsequent retransmission of the same data TB, the one or more corresponding transmit beams are considered as one or more updated candidate beams for the another UE or the group of another UEs.

In some embodiments, if not every another UE has reported ACK and/or a number of subset of transmit beams is high, the UE use a selected and/or determined subset of one or more transmit beams for a subsequent retransmission of the same data TB and repeats receiving the SL-HARQ report, selecting and/or determining the subset of one or more transmit beams based on the SL-HARQ report, and using the selected and/or determined subset of one or more transmit beams for the subsequent retransmission of the same data TB. In some embodiments, a selected/determined subset of one or more transmit beams is used by the UE for subsequent sidelink transmissions of data TBs in the same GC or UC communication until the process of tracking/updating of transmit beams and/or the process of beam failure recovery is performed. In some embodiments, during the beam management process, a transmit beam index/ID is indicated for each of the initial transmission and one or more subsequent retransmissions of the same data TB to the another UE or the group of another UEs. In some embodiments, for every data TB, the set of transmit beams is used by the UE for performing an initial transmission of the data TB in a GC communication.

In some embodiments, a MCSt is used by the UE in the initial transmission and one or more subsequent retransmissions of a data TB during the beam management process. In some embodiments, the SL-HARQ report includes a NACK for a best candidate beam in a PSFCH resource cycle/period only if there is a decoding failure. In some embodiments, for a same data TB, soft-bits of received PSSCH transmissions using different transmit beams are combined. In some embodiments, a measurement of each sidelink transmission in a GC communication is based on a PSCCH or PSSCH demodulation reference signal (DM-RS) for sidelink RSRP measurement. In some embodiments, the NACK of the SL-HARQ report is transmitted in a PSFCH corresponding to a best/highest measurement in each PSFCH resource cycle/period when at least one decoding attempt has failed and a decoding of the data TB is not successful. In some embodiments, at least one of the following is met: for DTX, no SL-HARQ report is transmitted in the PSFCH; and if the decoding of the data TB is successful within the PSFCH resource cycle/period, a decoding attempt for the same data TB is stopped and no SL-HARQ report is transmitted for the PSFCH resource cycle/period.

In some embodiments, when the UE receives at least one NACK of the SL-HARQ report and a maximum number of transmissions for the data TB is not reached, the UE selects and/or determines the subset of one or more transmit beams on a per data TB basis. In some embodiments, when the UE receives one or more NACK of the SL-HARQ report, the UE selects and/or determines the subset of one or more transmit beams corresponding to the one or more NACK of the SL-HARQ report and uses the subset of one or more transmit beams corresponding to the one or more NACK of the SL-HARQ report for the one or more subsequent retransmissions of the same data TB. In some embodiments, a selected and/or determined subset of one or more transmit beams is used for the one or more subsequent retransmissions of the same data TB, the beam management process is repeated until no more NACK of the SL-HARQ report is received by the UE or the maximum number of transmissions for the data TB has reached.

Commercial interests for some embodiments are as follows. 1. Solving issues in the prior art. 2. Providing a beam management for sidelink communication. 3. Improving a sidelink (SL) communication performance. 4. Minimizing/reducing a sidelink (SL) resource usage. 5. Providing high reliability. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, and beyond for providing direct device-to-device (D2D) wireless communication services.

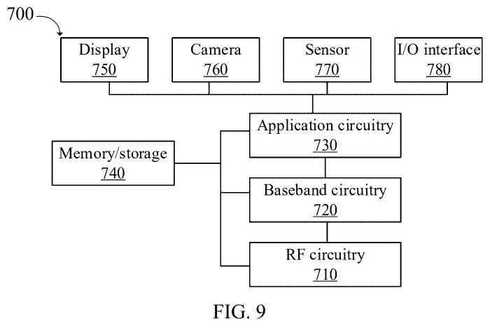

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method for beam management in sidelink communication by a user equipment (UE), comprising:
using a set of transmit beams to perform a sidelink transmission to another UE or a group of another UEs during a beam management process;
receiving, from the another UE or the group of another UEs, a sidelink hybrid automatic repeat request (SL-HARQ) report; and
selecting and/or determining a subset of one or more transmit beams based on the SL-HARQ report.

2. The method of claim 1, wherein the beam management process comprises a process of an initial selection of transmit beams, a process of tracking/updating of transmit beams, and/or a process of beam failure recovery.

3. The method of claim 1, wherein initiating/triggering of the beam management process is performed by the UE using a sidelink control information (SCI) signaling and/or a medium access control (MAC) control element (CE) signaling in a sidelink groupcast communication (GC).

4. The method of claim 1, wherein initiating/triggering of the beam management process is performed by the UE using an SCI signaling, a MAC CE signaling, and/or a PC5 radio resource control (RRC) signaling in a sidelink unicast communication (UC).

5. The method of claim 1, wherein a multi-consecutive slots transmission (MCSt) is used by the UE in an initial transmission and one or more subsequent retransmissions of a data transport block (TB) during the beam management process.

6. The method of claim 1, wherein the SL-HARQ report comprises an acknowledgement (ACK) and/or negative-acknowledgement (NACK) for a best candidate beam in a physical sidelink feedback channel (PSFCH) resource cycle/period.

7. The method of claim 1, wherein for a same data TB, soft-bits across different physical sidelink shared channel (PSSCH) transmissions using a same transmit beam are combined.

8. The method of claim 1, wherein a measurement of each sidelink transmission in a UC communication is based on a reference signal received power (RSRP) of channel state information reference signal (CSI-RS) for sidelink (SL CSI-RSRP).

9. The method of claim 1, wherein a measurement of each sidelink transmission in a GC communication is based on a PSCCH or PSSCH demodulation reference signal (DM-RS) for sidelink RSRP measurement.

10. The method of claim 1, wherein the SL-HARQ report is transmitted in a PSFCH based on a decoding result corresponding to a best/highest measurement in each PSFCH resource cycle/period,
wherein at least one of the following is met:
if the PSFCH resource cycle/period is one, the UE receives the SL-HARQ report is for every sidelink transmission;
for discontinuous transmission (DTX), no SL-HARQ report is transmitted in the PSFCH;
if at least one ACK is determined within the PSFCH resource cycle/period, only the ACK is reported; and
if more than one ACK per PSFCH resource cycle/period is determined, only the ACK corresponding to a highest measured RSRP is reported.

11. The method of claim 1, wherein based on the SL-HARQ report, the UE is configured to selects and/or determines the subset of one or more transmit beams on the another UE basis or the group of another UEs basis,
wherein at least one of the following is met:
based on the SL-HARQ report within the PSFCH resource cycle/period, the UE is configured to determine a suitability of the transmit beam used during a last round of SL transmission;
if the UE receives one or more ACKs from the another UE or the group of another UEs, one or more corresponding transmit beams are considered as one or more candidate beams for the another UE or the group of another UEs;
when the UE receives more than one ACK in a sidelink UC communication, the UE uses the corresponding transmit beams for sending a subsequent data TB to further down-select to a final best transmit beam for the another UE or the group of another UEs;
when the UE receives more than one ACK in a sidelink GC communication, the UE associates multiple candidate beams per another UE or the group of another UEs;
if no ACK is received and one or more NACKs are received by the UE, the transmit beams correspond to NACK feedback reports are considered as candidate beams to be used for a subsequent retransmission of a same data TB; and
when one or more ACKs are received by the UE for the subsequent retransmission of the same data TB, the one or more corresponding transmit beams are considered as one or more updated candidate beams for the another UE or the group of another UEs.

12. The method of claim 1, wherein if not every another UE has reported ACK and/or a number of subset of transmit beams is high, the UE use a selected and/or determined subset of one or more transmit beams for a subsequent retransmission of the same data TB and repeats receiving the SL-HARQ report, selecting and/or determining the subset of one or more transmit beams based on the SL-HARQ report, and using the selected and/or determined subset of one or more transmit beams for the subsequent retransmission of the same data TB.

13. The method of claim 1, wherein a selected/determined subset of one or more transmit beams is used by the UE for subsequent sidelink transmissions of data TBs in the same GC or UC communication until the process of tracking/updating of transmit beams and/or the process of beam failure recovery is performed.

14. The method of claim 1, wherein during the beam management process, a transmit beam index/ID is indicated for each of the initial transmission and one or more subsequent retransmissions of the same data TB to the another UE or the group of another UEs.

15. The method of claim 1, wherein for every data TB, the set of transmit beams is used by the UE for performing an initial transmission of the data TB in a GC communication.

16. The method of claim 15, wherein a MCSt is used by the UE in the initial transmission and one or more subsequent retransmissions of a data TB during the beam management process, wherein the SL-HARQ report comprises a NACK for a best candidate beam in a PSFCH resource cycle/period only if there is a decoding failure, wherein for a same data TB, soft-bits of received PSSCH transmissions using different transmit beams are combined.

17. The method of claim 15, wherein a measurement of each sidelink transmission in a GC communication is based on a PSCCH or PSSCH demodulation reference signal (DM-RS) for sidelink RSRP measurement, wherein the NACK of the SL-HARQ report is transmitted in a PSFCH corresponding to a best/highest measurement in each PSFCH resource cycle/period when at least one decoding attempt has failed and a decoding of the data TB is not successful,
wherein at least one of the following is met:
for DTX, no SL-HARQ report is transmitted in the PSFCH; and
if the decoding of the data TB is successful within the PSFCH resource cycle/period, a decoding attempt for the same data TB is stopped and no SL-HARQ report is transmitted for the PSFCH resource cycle/period.

18. The method of claim 15, wherein when the UE receives at least one NACK of the SL-HARQ report and a maximum number of transmissions for the data TB is not reached, the UE selects and/or determines the subset of one or more transmit beams on a per data TB basis,
wherein when the UE receives one or more NACK of the SL-HARQ report, the UE selects and/or determines the subset of one or more transmit beams corresponding to the one or more NACK of the SL-HARQ report and uses the subset of one or more transmit beams corresponding to the one or more NACK of the SL-HARQ report for the one or more subsequent retransmissions of the same data TB,
wherein a selected and/or determined subset of one or more transmit beams is used for the one or more subsequent retransmissions of the same data TB, the beam management process is repeated until no more NACK of the SL-HARQ report is received by the UE or the maximum number of transmissions for the data TB has reached.

19. A user equipment (UE), comprising:
a memory;
a transceiver; and
a processor coupled to the memory and the transceiver;
wherein the UE is configured to:
use a set of transmit beams to perform a sidelink transmission to another UE or a group of another UEs during a beam management process;
receive, from the another UE or the group of another UEs, a sidelink hybrid automatic repeat request (SL-HARQ) report; and
select and/or determine a subset of one or more transmit beams based on the SL-HARQ report.

20. A non-transitory machine-readable storage medium having stored thereon instructions that, when executed by a computer, cause the computer to:
use a set of transmit beams to perform a sidelink transmission to another UE or a group of another UEs during a beam management process;
receive, from the another UE or the group of another UEs, a sidelink hybrid automatic repeat request (SL-HARQ) report; and
select and/or determine a subset of one or more transmit beams based on the SL-HARQ report.
